(19) United States
(12) Patent Application Publication
(10) Pub. No.: US 2002/0177540 A1
(43) Pub. Date: Nov. 28, 2002

(54) Liquid compositions for sanitizing and cleaning carpets with reduced color damage to carpets

(75) Inventors: Valentina Masotti, Casalecchio di Reno (IT); Renzo Rizzo, Rome (IT); Luca Sarcinelli, Palermo (IT)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter and Gamble Company

(21) Appl. No.: 10/151,540

(22) Filed: May 20, 2002

Related U.S. Application Data
(63) Continuation of application No. 09/582,784, filed on Jul. 3, 2000, now abandoned.

(30) Foreign Application Priority Data
Apr. 8, 1998 (EP) 98870076.1

(51) Int. Cl. C11D 17/00

(52) U.S. Cl. 510/278; 510/446; 510/309; 510/499

(57) ABSTRACT

The present invention relates to a liquid composition suitable for cleaning and sanitising carpets, comprising a peroxygen bleach, said composition being packaged in a container adapted to deliver the composition onto the carpet in the form of a spray of droplets having a particle size distribution with a mean diameter D(v,0.9) of less than 1500 microns. The present invention provides excellent cleaning performance as well as sanitising properties on the carpet, while reducing colour damage on carpets.

### TECHNICAL FIELD

The present invention relates to liquid compositions suitable for sanitizing and cleaning carpets.

### BACKGROUND OF THE INVENTION

Carpets produced from synthetic or natural fibers and mixtures thereof are commonly used in residential and commercial applications as a floor covering. Various types of fibers can be used in making carpets such as polyamide fibers, polyester fibers as well as wool, cotton or even silk in the case of rugs.

However, carpets irrespective of whether they are made from natural or synthetic fibers are all prone to soiling and staining when contacted with many household items. Foods, grease, oils, beverages in particular such as coffee, tea and soft drinks especially those containing acidic dyes can cause unsightly, often dark stains on carpets. Also fibers may become soiled as a result of dirt particles, clay, dust, i.e., particulate soils in general, coming into contact with and adhering to the fibers of the carpet. These latter soils often appear in the form of a diffuse layer of soils rather than in the form of spots and tend to accumulate particularly in the so called “high traffic areas” such as near doors as a result of intensive use of the carpets in such areas.

Furthermore a major concern in the care of carpeting, besides the overall cleaning performance desired for a given cleaning method is sanitizing. Indeed it is important to reduce or even prevent microbial contamination on carpet surfaces. This is especially important in houses with pets, hotels or in hospitals and other health care facilities, where the presence of micro-organisms like bacteria should be kept to a minimum.

It is already known to use cleaning and sanitizing compositions based on peroxygen bleach like hydrogen peroxide.

However, there are some limitations to the convenience of peroxygen bleach. In particular, we have observed that peroxygen bleach-containing compositions may damage the colour of the carpets treated therewith, i.e. when applied directly (neat) onto the carpets, and left to act onto said carpets for prolonged periods of time before evaporating and/or being mechanically removed by for example a vacuum cleaner.

It is thus an object of the present invention to provide improved colour safety to carpets when treating said carpets with liquid peroxygen bleach-containing compositions.

We have now found that this object is efficiently met by packing a liquid composition comprising a peroxygen bleach in a container adapted to deliver said composition in the form of a spray of droplets having a particle size distribution with a mean diameter D(v,0.9) of less than 1500 microns. Indeed, it has now been found that by applying a liquid composition comprising a peroxygen bleach in the form of a spray of small droplets as defined herein, onto the soiled/stained carpets, it is possible to reduce the colour damage of said carpets, as compared to applying the same liquid composition in a form of spray of droplets of higher particle size onto the carpets.

An advantage of the present invention is that the compositions of the present invention are applicable to all carpet types, especially delicate natural fibres and are safe to all carpet dye types, particularly sensitive natural dyes used therein. The present invention is also suitable to be used to clean upholstery and car seats covering. The compositions herein may suitably be used to treat localised areas of carpets or the whole carpet.

Another advantage of the present invention is that excellent overall cleaning performance on various types of stains including particulate stains, greasy stains, bleachable stains and/or enzymatic stains and excellent sanitising performance is provided in an easy and fast way while requiring low amount of composition.

Yet another advantage of the compositions of the present invention is that they may be applied directly on the carpet without causing damage to the carpet fibres. In addition the cleaning action of the invention commences as soon as the carpet cleaning composition has been applied to the surface of the carpet.

Preferred compositions according to the present invention further comprise a polymer to further enhance the overall cleaning performance of these compositions. More particularly, in its preferred embodiment the present invention provides liquid compositions comprising a peroxygen bleach and a polymer, which can be used to clean and sanitise a carpet while reducing or even preventing resoiling of the carpet after having been cleaned/sanitised, and reducing or even preventing microbial redeposition and/or microbial re-growth.

Advantageously, the present invention provides a composition which delivers excellent sanitising and cleaning performance without requiring manual action (except for the application) by the user while the composition is in a wet state, especially when at least a polymer is present on top of the peroxygen bleach. Indeed, the preferred liquid compositions of the present invention comprising a peroxygen bleach and a polymer have the ability to dry to non-tacky residues which entrap the soils and the micro-organisms present thereby reducing or even preventing the soils and the micro-organisms re-deposition on the carpet cleaned. These residues (with the entrapped soils and micro-organisms) are easily removed by vacuum cleaning the carpet without the need of any other additional effort by the user such as rinsing or manual action like brushing.

### BACKGROUND ART

The following documents are representative of the prior art available on carpet cleaning compositions.

EP-A-629 694 discloses the use of stable aqueous compositions comprising a source of active oxygen, having a pH of from 1 to 6, for the cleaning of carpets. EP-A-751 213 discloses a carpet cleaning composition comprising salicylic acid, and a compound selected from the group consisting of amine oxides, soil suspending polycarboxylate or polyamine polymers, hydroxy-pyridine N-oxides, chelating agents and mixtures thereof.

None of these documents discloses the compositions of the present invention comprising a peroxygen bleach and being packaged in a container adapted to deliver the composition in the form of a spray of droplets having a particle size distribution with a mean diameter D(v,0.9) of less than 1500 microns.

### SUMMARY OF THE INVENTION

The present invention encompasses a liquid composition suitable for cleaning and sanitising carpets, comprising a peroxygen bleach, said composition being packaged in a container adapted to deliver the composition onto the carpet in the form of a spray of droplets having a particle size distribution with a mean diameter D(v,0.9) of less than 1500 microns. In a preferred embodiment said composition further comprises at least a polymer or a mixture thereof.

The present invention further encompasses a method of cleaning a carpet wherein a composition has described herein before, is applied to said carpet in the form of a spray of droplets having a particle size distribution with a mean diameter D(v,0.9) of less than 1500 microns, left to dry onto said carpet before being optionally removed from said carpet.

The present invention also encompasses the use of a liquid composition comprising a peroxygen bleach, said composition being packaged in a container adapted to deliver the composition in the form of a spray of droplets having a particle size distribution with a mean diameter D(v,0.9) of less than 1500 microns, for cleaning and sanitizing a carpet, for reducing the colour damage on said carpet.

All amounts, percentages and ratios are given by weight of the total composition in its neat form unless otherwise stated.

### DETAILED DESCRIPTION OF THE INVENTION

The Composition

The compositions of the present invention are formulated as liquid compositions. Preferred compositions herein are aqueous compositions.

Peroxygen bleaches

The compositions of the present invention comprise a peroxygen bleach or a mixture thereof, as an essential ingredient.

A preferred peroxygen bleach for use herein is hydrogen peroxide or a source thereof. As used herein a hydrogen peroxide source refers to any compound which produces perhydroxyl ions when said compound is in contact with water.

The presence of a peroxygen bleach, preferably hydrogen peroxide, contributes to the excellent cleaning (especially on bleachable stains) and sanitizing benefits of the compositions of the present invention.

Suitable water-soluble sources of hydrogen peroxide for use herein include percarbonates, persilicate, persulphate such as monopersulfate, perborates, preformed peroxyacids, alkyl hydroperoxides, peroxides, aliphatic diacyl peroxides and mixtures thereof. Hydrogen peroxide is preferred to be used in the compositions according to the present invention.

Suitable preformed peroxyacids for use in the compositions herein include diperoxydodecandioic acid DPDA, magnesium perphthalatic acid, perlauric acid, perbenzoic acid, diperoxyazelaic acid and mixtures thereof.

Suitable hydroperoxides for use herein are tert-butyl hydroperoxide, cumyl hydroperoxide, 2,4,4-trimethylpentyl-2-hydroperoxide, di-isopropylbenzene-monohydroperoxide, tert-amyl hydroperoxide, 2,5-dimethyl-hexane-2,5-dihydroperoxide or mixtures thereof.

Suitable aliphatic diacyl peroxides for use herein are dilauroyl peroxide, didecanoyl peroxide, dimyristoyl peroxide or mixtures thereof.

Typically, the liquid compositions herein comprise from 0.01% to 20% by weight of the total composition of a peroxygen bleach, or mixtures thereof, preferably from 0.5% to 10%, and more preferably from 1% to 7%.

The Container

An essential feature of the invention herein is that the composition is packaged in a container adapted to deliver the composition on the carpet in the form of a spray of droplets having a particle size distribution with a mean diameter D(v,0.9) of less than 1500 microns.

Preferably suitable containers according to the present invention are able to deliver the composition onto the carpet in the form of a spray of droplets having a particle size distribution with a mean diameter D(v,0.9) of less than 1000 microns, preferably of less than 750 microns, more preferably less than 500 microns, and most preferably from 350 microns to 10 microns.

It has now been found that by applying the liquid composition onto the surface of the carpet in the form of a spray of droplets having a particle size distribution with a mean diameter D(v,0.9) of less than 1500 microns, improved colour safety is delivered.

Actually, the present invention is based on the finding that the colour damage of some kinds of dyes present on carpets, i.e. the colour change and/or decoloration, is reduced when a liquid composition comprising a peroxygen bleach is applied onto the carpet in the form of a spray of droplets having a particle size distribution with a mean diameter D(v,0.9) of less than 1500 microns, as compared to the colour damage observed when treating the carpets by directly pouring thereto the same liquid composition or applying it thereto in the form of a spray of bigger droplets. In other words, spraying a liquid composition comprising a peroxygen bleach, as described herein, onto soiled carpets allows to prevent/reduce the decomposition (oxidation) of dyes generally present on the surface of carpet fibres (e.g. bleach sensitive dyes and/or metallized dyes including copper-formazan dyes and/or metal-azo dyes).

The colour damage of a carpet sample may be evaluated by measuring the colour deviation (DE) for example by employing the colour damage method, as can be seen in the examples hereinafter. This method consists in measuring the colour deviation (DE) with “The Hunterlab tristimulus MINISCAN”. By “colour deviation” it is to be understood the difference when comparing the colour of a carpet sample taken as a reference, e.g., wherein the composition is simply poured or applied via a spray dispenser that delivers the composition in the form of a spray of bigger droplets, e.g. a trigger spray dispenser which delivers the composition in the form of a spray of droplets having a particle size distribution with a mean diameter D(v,0.9) of 1800 microns or more like the S.C. Johnson Shout®.

By “mean diameter D(v,0.9) of less than 1500 microns” for a droplet size distribution it is meant that 90% of the spray of droplets dispensed (expressed in volume unit) has a droplet diameter of less than 1500 microns. For instance, a D(v,0.9) of less than 1500 microns indicates that 90% of the total sprayed volume is dispensed with droplets whose diameter is less than 1500 microns.

The particle size distribution of a spray of droplets can be determined by following the procedure detailed herebelow:

A suitable test equipment is the Malvern Mastersizer S LongBed® with 1000 mm lens and a maximum particle size range of 3475 microns. The Malvern Mastersizer S LongBed® provides 21 cm opening (between lenses) to accommodate spray flow. In all readings at the Malvern®, the lens surface must remain free of spray contamination. In the present setup procedure, the distance from nozzle to laser was fixed at 8 cm, this to minimise lens contamination. At 8 cm distance, the spray was directed to the laser beam to place the laser center to the spray cone. At least three readings have to be made for each composition sprayed to determine the particle size distribution of the spray of droplets. The sprayer used in the test according to the present invention was an electrically operated sprayer. With the battery driven system a “Full charge” test was held consistent by holding the spray head to 3.9 voltage direct current (vdc) from an external power supply, this to insure a consistent spray force. A reference sprayer used herein is a hand trigger operated sprayer. Hand trigger systems have to be tested against repeatability with three different persons. These persons chosen for their varied ability to actuate the trigger against force: Small female, female with strong finger strength, and medium male.

Any container adapted to deliver a spray of droplets as defined herein are suitable for use herein. Several modifications can be made to the conventional, single aperture, spray head to ensure that a spray of such droplets as required herein is formed. Suitable containers to be used herein (also called “spray dispensers”) share the common feature of having at least one aperture or a plurality of apertures also called “dispensing openings” through which the composition is dispensed so as to produce the spray of droplets as defined herein.

Typically the composition output from the container herein is from 5 ml/minute to 750 ml/minute, preferably from 20 ml/minute to 400 ml/minute, more preferably from 150 ml/minute to 250 ml/minute.

These spray dispensers may be manually or electrically operated. Typical manually operated spray dispensers include pump operated ones or trigger operated ones. Indeed, in such a container with a spray dispenser head the composition contained in the container is directed through the spray dispenser head via energy communicated to a pumping mechanism by the user as said user activates said pumping mechanism or to an electrically driven pump. Preferred herein is to use a container wherein the means for delivering the composition comprises an electrically driven pump and a spray arm being either extended or extendible and having at least one dispensing opening so that in operation, the composition is pumped by electrically driven pump from the container, through the spray arm to the dispensing opening from which it is dispensed. It is preferred that the spray arm communicates with the container by means of a flexible connector. The spray arm may have one nozzle or multiple nozzles located along its length. The spray arm makes it easier to control where the composition is sprayed. The electrically driven pump may be, for example, a gear pump, an impeller pump, a piston pump, a screw pump, a peristaltic pump, a diaphragm pump, or any other miniature pump. In a highly preferred embodiment of the electrically driven pump for use herein the pump is a gear pump with a typical speed between 6000 rpm and 12000 rpm. The electrically driven pump is driven by a means such as an electric motor which typically produce a torque between 1 and 20 mN.m. The electric motor must in turn be provided with a power source. The power source may be either mains electricity (optionally via transformer), or it may be a throw-away battery or rechargeable battery. The spray arm may be rigidly extended. However such a spray arm can be difficult to store, and the spray arm is preferably extensible either by means of telescopic or foldable configuration.

The pH of the liquid compositions according to the present invention can be from 1 to 14. In a preferred embodiment, the recommended pH range is from 1 to 8, preferably between pH 1 and 7, more preferably between pH 2 and 6.5 and most preferably between 4 and 6.5. Indeed, it has been surprisingly found that cleaning performance is further improved at these preferred pH ranges. Also these preferred pH ranges contribute to the stability of hydrogen peroxide. Accordingly, the compositions herein may further comprise an acid or base to adjust pH as appropriate. The acids that may be used for these purposes can be organic or inorganic acids, preferably inorganic acids such as sulphuric acid.

The bases to be used herein can be organic or inorganic bases, preferably inorganic bases such as sodium hydroxide.

Optional Ingredients

The compositions herein may further comprise a number of additional compounds such as polymers, volatile organic compounds, surfactants, stabilising agents, chelating agents, builder systems, perfumes, dyes, suds suppressing agents, enzymes, photobleaching agents, bleach activators and other minors.

The Polymers

The compositions of the present invention may further comprise a polymer or a mixture thereof, as a highly preferred optional ingredient.

Typically, the compositions herein may comprise from 0.01% to 50% by weight of the total composition of a polymer or a mixture thereof, preferably from 0.1% to 20%, more preferably from 0.3% to 10% and most preferably from 0.5% to 3%.

The polymers desired herein are those which do not dry as tacky residues.

Suitable polymers for use herein include any soil suspending polycarboxylate polymer as well as any soil suspending polyamine polymer and mixtures thereof.

Any soil suspending polycarboxylate polymer known to those skilled in the art can be used according to the present invention such as homo- or co-polymeric polycarboxylic acids or their salts including polyacrylates and copolymers of maleic anhydride or/and acrylic acid and the like. Indeed, such soil suspending polycarboxylate polymers can be prepared by polymerizing or copolymerizing suitable unsaturated monomers, preferably in their acid form. Unsaturated monomeric acids that can be polymerized to form suitable polymeric polycarboxylates include acrylic acid, maleic acid (or maleic anhydride), fumaric acid, itaconic acid, aconitic acid, mesaconic acid, citraconic acid and methylenemalonic acid. The presence in the polymeric polycarboxylates herein of monomeric segments, containing no carboxylate radicals such as vinylmethyl ether, styrene, ethylene, etc. is suitable provided that such segments do not constitute more than about 40% by weight.

Particularly suitable polymeric polycarboxylates to be used herein can be derived from acrylic acid. Such acrylic acid-based polymers which are useful herein are the water-soluble salts of polymerized acrylic acid. The average molecular weight of such polymers in the acid form preferably ranges from about 2,000 to 10,000, more preferably from about 4,000 to 7,000 and most preferably from about 4,000 to 5,000. Water-soluble salts of such acrylic acid polymers can include, for example, the alkali metal, ammonium and substituted ammonium salts. Soluble polymers of this type are known materials. Use of polyacrylates of this type in detergent compositions has been disclosed, for example, in Diehl, U.S. Pat. No. 3,308,067, issued Mar. 7, 1967.

Acrylic/maleic-based copolymers may also be used as a preferred soil suspending polycarboxylic polymer. Such materials include the water-soluble salts of copolymers of acrylic acid and maleic acid. The average molecular weight of such copolymers in the acid form preferably ranges from about 2,000 to 100,000, more preferably from about 5,000 to 75,000, most preferably from about 7,000 to 65,000. The ratio of acrylate to maleate segments in such copolymers will generally range from about 30:1 to about 1:1, more preferably from about 10:1 to 2:1. Water-soluble salts of such acrylic acid/maleic acid copolymers can include, for example, the alkali metal, ammonium and substituted ammonium salts. Soluble acrylate/maleate copolymers of this type are known materials which are described in European Patent Application No. 66915, published Dec. 15, 1982. Particularly preferred is a copolymer of maleic/acrylic acid with an average molecular weight of about 70,000. Such copolymers are commercially available from BASF under the trade name SOKALAN CP5.

Any soil suspending polyamine polymer known to those skilled in the art may also be used herein. Particularly suitable polyamine polymers for use herein are alkoxylated polyamines. Such materials can conveniently be represented as molecules of the empirical structures with repeating units:

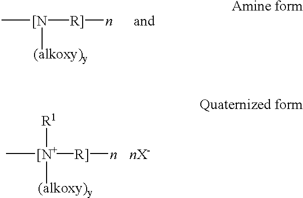

wherein R is a hydrocarbyl group, usually of 2-6 carbon atoms; R¹ may be a C₁-C₂₀ hydrocarbon; the alkoxy groups are ethoxy, propoxy, and the like, and y is 2-30, most preferably from 10-20; n is an integer of at least 2, preferably from 2-20, most preferably 3-5; and X³¹ is an anion such as halide or methylsulfate, resulting from the quaternization reaction.

The most highly preferred polyamines for use herein are the so-called ethoxylated polyethylene amines, i.e., the polymerized reaction product of ethylene oxide with ethyleneimine, having the general formula:

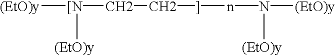

when y=2-30, preferably 15 and n is 1-30 preferably 4. Particularly preferred for use herein is an ethoxylated polyethylene amine, in particular ethoxylated tetraethylenepentamine, and quaternized ethoxylated hexamethylene diamine.

It has now been found that the presence of the polymer in the compositions herein further contributes to the overall cleaning performance as well as excellent sanitising performance of the compositions herein, while reducing or even preventing the formation of tacky residues on the surface of the carpet upon drying, as compared to the same compositions but without the polymer.

Indeed, it has been observed that with the compositions of the present invention which comprise said peroxygen bleach and polymer, more than 90%, preferably more than 95% of the residues left onto the carpet fibres are solid and non tacky. This results in a method of cleaning carpets whereby the residues left onto the carpets are removed more easily as opposed to residues being sticky, and thus difficult to remove by vacuum cleaning said carpets. By almost completely removing the residues the present invention reduces or even prevents soil re-deposition on the carpet.

Furthermore, by almost completely removing the residues the present invention reduces or even prevents microbial re-deposition and/or microbial re-growth. Indeed, the present invention allows fast evaporation of the composition when applied in the form of a spray of droplets having a particle size distribution with a mean diameter D(v,0.9) of less than 1500 microns. This results in residues having lower levels of moisture. Thus, these residues do not represent a fertile environment for bacterial re-growth. It has now been observed than when applying a composition comprising peroxygen bleach and a polymer in the form of a spray of droplets having a particle size distribution with a bigger mean diameter D(v,0.9), the residues formed with the soils on the carpet upon evaporation trap higher levels of moisture which makes the residues a more fertile environment for microbial re-deposition and re-growth.

Advantageously the present invention provides excellent sanitising on a broad range of bacterial pure strains including Gram positive bacteria like S. aureus and Gram negative bacteria like E. Coli, Ps. aeruginosa as well as more resistant micro-organisms like fungi like Candida albicans.

Volatile Organic Compounds

Preferred compositions according to the present invention typically comprise a volatile organic compound (VOC) or a mixture thereof. Typically, the compositions herein comprise up to 90% by weight of the total composition of a volatile organic compound or a mixture thereof, preferably from 0.1% to 20%, more preferably from 1.5% to 10% and most preferably from 2% to 8%.

Suitable volatile organic compounds for use herein include aliphatic and/or aromatic alcohol, glycol ethers and/or derivatives thereof, polyol and mixtures thereof.

Suitable aromatic alcohols to be used herein are according to the formula R₁—OH wherein R₁ is an alkyl substituted or non-alkyl substituted aryl group of from 1 to 20 carbon atoms, preferably from 2 to 15 and more preferably from 2 to 10. A suitable aromatic alcohol to be used herein is benzyl alcohol.

Suitable aliphatic alcohols to be used herein are according to the formula R₂—OH wherein R₂ is a linear or branched saturated or unsaturated hydrocarbon chain of from 1 to 20 carbon atoms, preferably from 1 to 10 and more preferably from 2 to 6. Highly preferred herein are aliphatic alcohols with 2 to 4 carbon atoms and most preferably 4 carbon atoms, or mixtures thereof. Suitable aliphatic alcohols to be used herein include linear alcohol like 2-octanol, decanol, isopropyl alcohol, propyl alcohol, ethanol and/or methanol. Highly preferred herein is isopropyl alcohol.

Isopropanol may be commercially available from Merck/BDH Italia under its chemical name.

Suitable glycol ethers and/or derivatives thereof to be used herein include monoglycol ethers and/or derivatives thereof, polyglycol ethers and/or derivatives thereof and mixtures thereof.

Suitable monoglycol ethers and derivatives thereof to be used herein include n-buthoxypropanol (n-BP), water-soluble CELLOSOLVE® solvents or mixtures thereof. Preferred Cellosolve® solvents include propoxy ethyl acetate salt (i.e., Propyl Cellosolve acetate salt®), ethanol-2-butoxy phosphate salt (i.e., Butyl Cellosolve phosphate salt®), 2-(Hexyloxy)ethanol (i.e., 2-hexyl Cellosolve®), 2-ethoxy ethanol (i.e., 2-ethyl Cellosolve®), 2-butoxyethanol (i.e., 2-buthyl Cellosolve®) or mixtures thereof.

Suitable polyglycol ethers and derivatives thereof to be used herein include n-butoxypropoxypropanol (n-BPP), butyl triglycol ether (BTGE), butyl diglycol ether (BDGE), water-soluble CARBITOL® solvents or mixtures thereof.

Preferred water-soluble CARBITOL® solvents are compounds of the 2-(2-alkoxyethoxy)ethanol class, 2-(2-alkoxyethoxy)propanol class and/or 2-(2-alkoxyethoxy)butanol class wherein the alkoxy group is derived from ethyl, propyl or butyl. A preferred water-soluble carbitol is 2-(2-butoxyethoxy)ethanol also known as butyl carbitol®.

Preferred glycol ethers and/or derivatives thereof are 2-ethoxyethanol, 2-butoxyethanol, n-butoxypropoxypropanol, butyl carbitol® or mixtures thereof.

Suitable polyol solvents to be used herein are the polyols having at least 2 hydroxyl groups (—OH) like diols. Suitable diols to be used herein include 2-ethyl-1,3-hexanediol, 2,2,4-trimethyl-1,3-pentanediol, methyl-2,4 pentanediol or mixture thereof.

In a preferred embodiment herein the volatile organic compounds are present as they further contribute to the excellent overall cleaning performance of the present invention. Additionally, their addition in the compositions herein also enhances the sanitising properties of the compositions.

Surfactants

Preferred compositions according to the present invention typically comprise a surfactant or a mixture thereof. Typically, the compositions herein comprise from up to 50% by weight of the total composition of a surfactant or a mixture thereof, preferably from 0.1% to 20%, more preferably from 1% to 10% and most preferably from 1.5% to 5%.

Suitable surfactants for use herein have the ability to not dry as tacky residues.

Such surfactants may be selected from those well known in the art including anionic, nonionic, zwitterionic, amphoteric and cationic surfactants and mixtures thereof.

Particularly suitable surfactants to be used herein are anionic surfactants. Said anionic surfactants are preferred herein as they further contribute to the outstanding stain removal performance of the compositions of the present invention on various type of stains. Moreover they do not stick on carpet, thereby reducing resoiling.

Suitable anionic surfactants for use herein include sulfonate and sulfate surfactants. The like anionic surfactants are well-known in the art and have found wide application in commercial detergents. These anionic surfactants include the C8-C22 alkyl benzene sulfonates (LAS), the C4-C22 alkyl sulfates (AS), unsaturated sulfates such as oleyl sulfate, the C10-C18 alkyl alkoxy sulfates (AES) and the C10-C18 alkyl alkoxy carboxylates. The neutralising cation for the anionic synthetic sulfonates and/or sulfates is represented by conventional cations which are widely used in detergent technology such as sodium, potassium or alkanolammonium. Preferred herein are the alkyl sulphate, especially coconut alkyl sulphate having from 6 to 18 carbon atoms in the alkyl chain, preferably from 8 to 15, or mixtures thereof.

Other anionic surfactants useful for detersive purposes can also be used herein. These can include salts (including, for example, sodium, potassium, ammonium, and substituted ammonium salts such as mono-, di- and triethanolamine salts) of soap, C₈-C₂₂ primary or secondary alkanesulfonates, C₈-C₂₄ olefinsulfonates, sulfonated polycarboxylic acids prepared by sulfonation of the pyrolyzed product of alkaline earth metal citrates, e.g., as described in British patent specification No. 1,082,179, C₈-C₂₄ alkylpolyglycolethersulfates (containing up to 10 moles of ethylene oxide); alkyl ester sulfonates such as C₁₄₋₁₆ methyl ester sulfonates; acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), sulfates of alkylpolysaccharides such as the sulfates of alkylpolyglucoside (the nonionic nonsulfated compounds being described below). Resin acids and hydrogenated resin acids are also suitable, such as rosin, hydrogenated rosin, and resin acids and hydrogenated resin acids present in or derived from tall oil. Further examples are given in “Surface Active Agents and Detergents” (Vol. I and II by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23 (herein incorporated by reference).

Other suitable anionic surfactants to be used herein also include acyl sarcosinate or mixtures thereof, in its acid and/or salt form, preferably long chain acyl sarcosinates having the following formula:

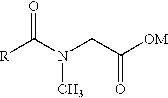

wherein M is hydrogen or a cationic moiety and wherein R is an alkyl group of from 11 to 15 carbon atoms, preferably of from 11 to 13 carbon atoms. Preferred M are hydrogen and alkali metal salts, especially sodium and potassium. Said acyl sarcosinate surfactants are derived from natural fatty acids and the amino-acid sarcosine (N-methyl glycine). They are suitable to be used as aqueous solution of their salt or in their acidic form as powder. Being derivatives of natural fatty acids, said acyl sarcosinates are rapidly and completely biodegradable and have good skin compatibility.

Accordingly, particularly preferred long chain acyl sarcosinates to be used herein include C₁₂ acyl sarcosinate (i.e. an acyl sarcosinate according to the above formula wherein M is hydrogen and R is an alkyl group of 11 carbon atoms) and C₁₄ acyl sarcosinate (i.e. an acyl sarcosinate according to the above formula wherein M is hydrogen and R is an alkyl group of 13 carbon atoms). C₁₂ acyl sarcosinate is commercially available, for example, as Hamposyl L-30® (supplied by Hampshire. C₁₄ acyl sarcosinate is commercially available, for example, as Hamposyl M-30® supplied by Hampshire.

Particularly preferred anionic surfactants for use are the alkyl sulphate surfactants according to the formula R₁SO₄M wherein R₁ represents a hydrocarbon group selected from the group consisting of straight or branched alkyl radicals containing from 4 to 22 carbon atoms and alkyl phenyl radicals containing from 6 to 15 carbon atoms in the alkyl group. Preferably R1 is a straight or branched alkyl radical containing from 6 to 18 carbon atoms, more preferably from 6 to 12 and most preferably from 6 to 10. M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Other particularly suitable surfactants to be used herein include amine oxide surfactants according to the formula R1R2R3NO, wherein each of R1, R2 and R3 is independently a saturated substituted or unsubstituted, linear or branched alkyl groups of from 1 to 30 carbon atoms, preferably of from 1 to 20 carbon atoms, and mixtures thereof.

Particularly preferred amine oxide surfactants to be used according to the present invention are amine oxide surfactants having the following formula R₁R₂R₃NO wherein R1 is a saturated linear or branched alkyl group of from 1 to 30 carbon atoms, preferably of from 6 to 20 carbon atoms, more preferably of from 6 to 16 carbon atoms, and wherein R2 and R3 are independently substituted or unsubstituted, linear or branched alkyl groups of from 1 to 4 carbon atoms, preferably of from 1 to 3 carbon atoms, and more preferably are methyl groups. Preferred amine oxide surfactants used herein are pure-cut amine oxide surfactants, i.e., a pure single amine oxide surfactant, e.g. C₈ N,N-dimethyl amine oxide, as opposed to mixtures of amine oxide surfactants of different chain lengths

Suitable amine oxide surfactants for use herein are for instance pure cut C8 amine oxide, pure cut C10 amine oxide, pure cut C14 amine oxide, natural blend C8-C10 amine oxides as well as natural blend C12-C16 amine oxides. Such amine oxide surfactants may be commercially available from Hoechst or Stephan.

Suitable nonionic surfactant for use herein include any ethoxylated C₆-C₂₄ fatty alcohol nonionic surfactant, alkyl propoxylates and mixtures thereof, fatty acid C₆-C₂₄ alkanolamides, C₆-C₂₀ polyethylglycol ethers, polyethylene glycol with molecular weight 1000 to 80000 and glucose amides, alkyl pyrrolidones, betaines.

Suitable cationic surfactants for use herein include quaternary ammonium compounds of the formula R₁R₂R₃R₄N⁺ where R₁,R₂ and R₃ are methyl groups, and R₄ is a C₁₂₋₁₅ alkyl group, or where R₁ is an ethyl or hydroxy ethyl group, R₂ and R₃ are methyl groups and R₄ is a C₁₂₋₁₅ alkyl group.

Zwitterionic surfactants are also suitable optional ingredients for use herein. Suitable zwitterionic surfactants include derivatives of aliphatic quaternary ammonium, phosphonium, and sulphonium compounds in which the aliphatic moiety can be straight or branched chain and wherein one of the aliphatic substituents contains from about 8 to about 24 carbon atoms and another substituent contains, at least, an anionic water-solubilizing group. Particularly preferred zwitterionic materials are the ethoxylated ammonium sulphonates and sulfates disclosed in U.S. Pat. Nos. 3,925,262, Laughlin et al., issued Dec. 9, 1975 and 3,929,678, Laughlin et al., issued Dec. 30, 1975.

Preferred surfactants for use herein are the amine oxide surfactants and alkyl sulphate surfactants and mixture thereof and most preferred surfactants herein are alkyl sulphate surfactants.

In a preferred embodiment it has been found that optimum cleaning performance is delivered when combining the surfactant, preferably an alkyl sulphate, with the polymer preferably the polyamine polymer, at a weight ratio of the polymer to said surfactant of 1:40 to 20:1, preferably of 1:20 to 10:1, more preferably of 1:10 to 5:1 and most preferably of 1:6 to 1:1. Also the total level of surfactant together with polymer is from 1% to 20%, preferably from 2% to 10% and more preferably from 3% to 6% by weight of the total composition. Indeed an advantage of the present invention is that excellent cleaning performance is provided with reduced total amount of cleaning agent, i.e. surfactant and/or polymer.

These surfactants have the advantage of assisting the polymers herein when present, to form easily removable non-tacky residues upon drying on the surface of the carpet after having combined soils deposited thereto.

Stabilizing Agents

The compositions herein may also comprise a hydroxy pyridine N-oxides or derivatives thereof according to the following formula:

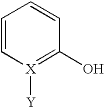

wherein X is nitrogen, Y is one of the following groups oxygen, —CHO, —OH, —(CH2)n-COOH, wherein n is an integer of from 0 to 20, preferably of from 0 to 10 and more preferably is 0, and wherein Y is preferably oxygen. Accordingly particularly preferred hydroxy pyridine N-oxides or derivatives thereof to be used herein is 2-hydroxy pyridine N-oxide.

Hydroxy pyridine N-oxides or derivatives thereof may be commercially available from Sigma.

Typically, the compositions herein comprise up to 2% by weight of the total composition of a hydroxy pyridine N-oxide or derivatives thereof or mixtures thereof, preferably from 0.001% to 1% and more preferably from 0.001% to 0.5%.

The compositions herein may also comprise a chelating agent or mixtures thereof. Suitable chelating agents are those known to those skilled in the art. Suitable chelating agents include for examples phosphonate chelating agents, polyfunctionally-substituted aromatic chelating agents, amino carboxylate chelating agents, other chelating agents like ethylene diamine N,N′- disuccinic acid and mixtures thereof. Typically, the compositions herein comprise up to 4% by weight of the total composition of a chelating agent or mixtures thereof, preferably from 0.001% to 1%, and more preferably from 0.001% to 0.5%.

Suitable phosphonate chelating agents to be used herein may include ethydronic acid, alkali metal ethane 1-hydroxy diphosphonates as well as amino phosphonate compounds, including amino alkylene poly (alkylene phosphonate), alkali metal ethane 1-hydroxy diphosphonates, nitrilo trimethylene phosphonates, ethylene diamine tetra methylene phosphonates, and diethylene triamine penta methylene phosphonates. The phosphonate compounds may be present either in their acid form or as salts of different cations on some or all of their acid functionalities. Preferred phosphonate chelating agents to be used herein are diethylene triamine penta methylene phosphonates (DETPMP). Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987. to Hartman and Perkins. Ethylenediamine N,N′-disuccinic acids is, for instance, commercially available under the tradename ssEDDS® from Palmer Research Laboratories.

Suitable amino carboxylate chelating agents to be used herein include ethylene diamine tetra acetates, diethylene triamine pentaacetates, diethylene triamine pentaacetate (DTPA), N-hydroxyethylethylenediamine triacetates, nitrilotri-acetates, ethylenediamine tetrapropionates, triethylenetetraaminehexa-acetates, ethanoldiglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein is diethylene triamine penta acetic acid (DTPA).

Other suitable chelating agents to be used herein include salicylic acid or derivatives thereof, or mixtures thereof according to the following formula:

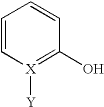

wherein X is carbon, Y is one of the following groups —CHO, —OH, —(CH2)n—COOH, and preferably is —(CH2)n—COOH, and wherein n is an integer of from 0 to 20, preferably of from 0 to 10 and more preferably is 0. Salicylic acid and derivatives thereof may be used herein either in their acid form or in their salts form as for example sodium salts.

Salicylic acid is particularly preferred herein and may be commercially available from Rhone Poulenc.

The compositions according to the present invention may further comprise propyl gallate up to a level of 1% by weight of the total composition, preferably from 0.01% to 0.1%, and more preferably from 0.01% to 0.06%. It has now been found that the addition of propyl gallate in the liquid preferred compositions herein comprising a peroxygen bleach contributes to deliver excellent chemical stability to said compositions.

Bleach Activators

The compositions according to the present invention may further comprise a bleach activator or mixtures thereof, as another optional ingredient. By “bleach activator”, it is meant herein a compound which reacts with hydrogen peroxide to form a peracid. The peracid thus formed constitutes the activated bleach. Suitable bleach activators to be used herein include those belonging to the class of esters, amides, imides, or anhydrides. Examples of suitable compounds of this type are disclosed in British Patent GB 1 586 769 and GB 2 143 231 and a method for their formation into a prilled form is described in European Published Patent Application EP-A-62 523. Suitable examples of such compounds to be used herein are tetracetyl ethylene diamine (TAED), sodium 3,5,5 trimethyl hexanoyloxybenzene sulphonate, diperoxy dodecanoic acid as described for instance in U.S. Pat. No. 4,818,425 and nonylamide of peroxyadipic acid as described for instance in U.S. Pat. No. 4,259,201 and n-nonanoyloxybenzenesulphonate (NOBS). Also suitable are N-acyl caprolactam selected from the group consisting of substituted or unsubstituted benzoyl caprolactam, octanoyl caprolactam, nonanoyl caprolactam, hexanoyl caprolactam, decanoyl caprolactam, undecenoyl caprolactam, formyl caprolactam, acetyl caprolactam, propanoyl caprolactam, butanoyl caprolactam pentanoyl caprolactam or mixtures thereof. A particular family of bleach activators of interest was disclosed in EP 624 154, and particularly preferred in that family is acetyl triethyl citrate (ATC). Acetyl triethyl citrate has the advantage that it is environmentally friendly as it eventually degrades into citric acid and alcohol. Furthermore, acetyl triethyl citrate has a good hydrolytical stability in the composition upon storage and it is an efficient bleach activator.

The compositions according to the present invention may comprise up to 30% by weight of the total composition of said bleach activator, or mixtures thereof, preferably from 1% to 20%, and more preferably from 2% to 10%.

Builders

The compositions according to the present invention may further comprise a builder system. Any conventional builder system known in the art is suitable for use herein. Suitable builders for use herein include derivatives of succinic acid of the formula R—CH(COOH)CH₂(COOH) wherein R is C₁₀₋₂₀ alkyl or alkenyl, preferably C₁₂₋₁₆, or wherein R can be substituted with hydroxyl, sulpho sulphoxyl or sulphone substituents. Specific examples include lauryl succinate, myristyl succinate, palmityl succinate, 2-dodecenylsuccinate, 2-tetradecenyl succinate. Succinate builders are preferably used in the form of their water-soluble salts, including sodium, potassium, ammonium and alkanolammonium salts.

Other suitable builders are oxodisuccinates and mixtures of tartrate monosuccinic and tartrate disuccinic acid such as described in U.S. Pat. No. 4,663,071.

Further suitable builders for use herein are fatty acid builders including saturated or unsaturated C₁₀₋₁₈ fatty acids, as well as the corresponding soaps. Preferred saturated species have from 12 to 16 carbon atoms in the alkyl chain. The preferred unsaturated fatty acid is oleic acid.

The compositions herein may comprise from 0% to 10%, preferably from 1% to 7% by weight of the total composition of a builder system.

The Method of Cleaning Carpets

The present invention also encompasses a method of cleaning and sanitising a carpet wherein a composition as described herein, is applied to said carpet, left to dry onto said carpet before being optionally removed from it. Preferably the step of leaving the composition to dry onto the carpet (drying step) can either be an “active drying step” or a “passive drying step”. By “active drying step” it is meant herein, performing an additional action to facilitate the evaporation of the volatile ingredients of the liquid composition as disclosed herein, preferably by means of application of hot air, infrared radiation and the like. By “passive drying step” it is meant herein, evaporation of the volatile ingredients of the liquid composition as disclosed herein without performing further action.

By “dry” it is meant herein the stage where at least 40%, preferably at least 60% of the initial amount of composition dispensed onto the carpet is lost due to evaporation.

In a preferred embodiment, further steps, as for example application of an additional cleaning composition, of a perfume and the like, may be performed before, in between and/or after any of the steps of the method of cleaning a carpet as described herein.

In the method of cleaning and sanitizing a carpet according to the present invention the step of applying a composition onto the carpets as described herein before, does not need to be followed by a step where manual action is required other than vacuum cleaning. Indeed the compositions herein allow excellent cleaning performance and sanitising performance without requiring any manual action like rubbing and/or brushing. An advantage of the present invention is that the cleaning and sanitising action of the present compositions commence as soon as said compositions are applied onto said carpet.

By applying the composition onto the carpet in the form of a spray of small droplets as defined herein, a higher coverage can be achieved with the same amount of composition, as compared to applying the same composition but in the form of a spray of bigger droplets.

Advantageously the present invention allows excellent cleaning and sanitising performance while requiring low amount of composition. Typically in the method of cleaning a carpet of the present invention the composition is applied/sprayed onto the carpet in an amount of from 1 ml to 120 ml by square meter of carpet, preferably from 10 ml to 80, more preferably from 20 ml to 60 ml and most preferably from 30 ml to 50 ml. Indeed, it is by combining this feature with the particle size distribution of the composition herein when sprayed as defined herein on the carpet that optimum coverage of the carpet surface is obtained resulting in more faster drying time. Furthermore, applying the composition on the carpet as mentioned herein, further translates in limited wetting of the surface and thus in faster drying of the composition. In other words, the housewife has to wait less time between the step of applying the composition on the carpet and those of removing it by for example vacuum cleaning the carpet.

Typically the composition is left to dry on the carpet for less than 2 hour, preferably less than 1 hour, more preferably less than 40 minutes, even more preferably from 1 to 30 minutes and most preferably from 5 to 25 minutes.

The area to be cleaned by applying preferably spraying the compositions according to the present invention may be of any size. Indeed, a complete section or more preferably the whole carpet may be sprayed with the composition for the cleaning of carpets according to the present invention.

In the method of cleaning a carpet according to the present invention the container, and especially the spray dispenser head is typically maintained at a distance of from 1 cm to 40 cm from the carpet onto which the composition will be sprayed, preferably from 2 cm to 30 cm more preferably from 3 cm to 20 cm.

Test Methods

Sanitising properties of a composition may be measured by the bactericidal activity of said composition. A test method suitable to evaluate the bactericidal activity of a composition on surfaces is described in European Standard, prEN 1040, CEN/TC 216 N 78, dated November 1995 issued by the European committee for standardisation, Brussels. European Standard, prEN 1040, CEN/TC 216 N 78, specifies a test method and requirements for the minimum bactericidal activity of a disinfecting composition. The test is passed if the bacterical colonies forming units (cfu) are reduced from a 10⁷ cfu (initial level) to a 10² cfu (final level after contact with the disinfecting product), i.e. a 10⁵ reduction of the viability is necessary. The compositions according to the present invention pass this test under very dirty conditions (1% Albumin).

The compositions for the cleaning of carpets according to the present invention provide excellent cleaning performance on various types of soils including diffuse soils (e.g., particulate and/or greasy soils) that tend to accumulate in the so called “high traffic areas” but also in delivering good cleaning performance on other types of stains or soils, i.e., on spot stains like bleachable stains (e.g., coffee, beverage, food) and/or enzymatic stains like blood.

By “particulate stains” it is meant herein any soils or stains of particulate nature that can be found on any carpet, e.g. clay, dirt, dust, mud, concrete and the like.

By “greasy/oily stains” it is meant herein any soils or stains of greasy/oily nature that can be found on any carpet, e.g., make-up, lipstick, dirty motor oil and mineral oil, greasy food like mayonnaise and spaghetti sauce.

By “bleachable stains” it is meant herein any soils or stains containing ingredients sensitive to bleach that can be found on any carpet, e.g., coffee or tea.

By “enzymatic stains” it is meant herein any soils or stains of enzymatic nature that can be found on any carpet, e.g., grass.

The cleaning performance of a given composition on a soiled carpet may be evaluated by the following test method. A liquid composition according to the present invention is first sprayed onto the stained portion of a carpet, left to act thereon from about 1 to about 10 minutes, preferably 5 minutes, after which the carpet is vacuum cleaned. Typical soils used in this test may be grass, dirty motor oil, tea, coffee, dust and/or mayonnaise. The cleaning performance may be evaluated by visual grading.

### EXAMPLES

The following examples will illustrate the present invention. The compositions are made by combining the listed ingredients in the listed proportions (weight % unless otherwise specified).

Compositions

| (weight %) | I | II | III | IV | V | VI | VII | VIII | IX | X | XI | XII |
|---|---|---|---|---|---|---|---|---|---|---|---|---|
| Hydrogen | 4.0 | 6.0 | 6.0 | 4.0 | 6.0 | 4.0 | 7.0 | 7.0 | 7.0 | 4.0 | 7.0 | 1.0 |
| peroxide | | | | | | | | | | | | |
| Na CnAS | 3.0 | — | 5.0 | — | — | — | 1.0 | — | 3.0 | 3.0 | 2.0 | 3.0 |
| PA | 1.0 | 3.0 | 0.2 | 2.0 | — | — | 0.8 | 1.0 | 1.0 | 1.0 | — | 0.9 |
| AMCP | — | 1.0 | 2.0 | — | — | — | — | — | — | — | 2.0 | 1.0 |
| Salicylic Acid | 0.5 | 0.01 | — | — | 0.1 | — | 0.03 | — | — | — | — | 0.03 |
| Chelant* | 0.2 | 0.01 | 0.1 | — | 0.2 | — | 0.03 | — | — | 0.2 | — | — |
| Benzyl alcohol | — | 1.0 | 3.0 | — | — | — | 3.0 | 4.0 | 5.0 | — | 1.0 | 3.0 |
| Isopropyl- | 3.0 | 1.0 | 1.0 | — | — | — | 0.5 | 1.5 | 1.0 | 3.0 | 1.0 | 1.0 |
| alcohol | | | | | | | | | | | | |
| Propyl Gallate | 0.03 | 0.03 | 0.1 | — | 0.03 | — | 0.01 | — | — | 0.03 | — | 0.02 |
| Water | Balance | Balance | Balance | Balance | Balance | Balance | Balance | Balance | Balance | Balance | Balance | Balance |
| up to pH | 6 | 6.5 | 5 | 6 | 6 | 5 | 4 | 7 | 6 | 6 | 6 | 8 |

AMCP is acrylic/malic based copolymers (Sokalan CP5®) Chelant* is a phosphonate chelant available under the trade name DEQUEST® Na CnAS is sodium alkyl sulphate.

PA is an ethoxylated tetraethylenepentamine, average molecular weight about 70,000.

The compositions exemplified above are packaged in a container adapted to deliver a spray of droplets having a particle size distribution with a mean diameter D(v,0.9) of 200 to 400 microns, when measured with Malvern Mastersizer S longBed® referenced herein before. A suitable container used was an electrically driven sprayer.

By spraying the above compositions by means of such a container as described above onto a carpet to cleaning and sanitize, excellent colour safety was observed.

The compositions in the examples above deliver excellent cleaning performance on particulate soil, greasy/oily soil, and/or enzymatic as well as on other types of soils such as bleachable stains like coffee, tea and the like as well as excellent sanitising properties.

1. A liquid composition suitable for cleaning and sanitising a carpet, comprising a peroxygen bleach, said composition being packaged in a container adapted to deliver the composition onto the carpet in the form of a spray of droplets having a particle size distribution with a mean diameter D(v,0.9) of less than 1500 microns.

2. A composition according to claim 1 wherein said container delivers the composition in the form of droplets having a particle size distribution with a mean diameter D(v,0.9) of less than 1000 microns, preferably less than 750 microns, more preferably less than 500 microns and most preferably from 350 to 10 microns.

3. A composition according to any of the preceding claims wherein said peroxygen bleach is selected from the group consisting of percarbonate, persilicate, persulphate, perborate, preformed peroxyacid, alkyl hydroperoxide, peroxide, aliphatic diacyl peroxide and mixtures thereof, and preferably is hydrogen peroxide.

4. A composition according to any of the preceding claims which comprises from 0.01% to 20% by weight of the total composition of a peroxygen bleach or a mixture thereof, preferably from 0.5% to 10% and more preferably from 1% to 7%.

5. A composition according to any of the preceding claims wherein said composition further comprises a polymer or a mixture thereof, preferably a soil suspending polycarboxylate polymer and/or a polyamine polymer, preferably an alkoxylated polyamine or mixture thereof represented as molecules of the empirical structures with repeating units: 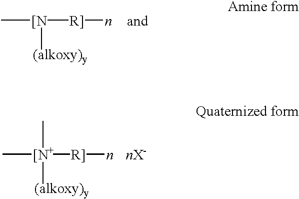
R¹
wherein R is a hydrocarbyl group, usually of 2-6 carbon atoms; R¹ is a C₁-C₂₀ hydrocarbon; the alkoxy groups are ethoxy and/or propoxy, and y is 2-30, most preferably from 10-20; n is an integer of at least 2, preferably from 2-20, most preferably 3-5; and X⁻ is an anion such as halide or methylsulfate, resulting from the quaternization reaction, and most preferably is an ethoxylated polyethylene amine or mixture thereof, according to the general formula: 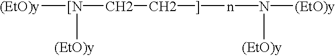
wherein y is from 2 to 30, preferably 15, and n is from 1 to 30, preferably 4.

6. A composition according to claim 5 which comprises from 0.01% to 50% by weight of the total composition of a polymer or mixtures thereof, preferably from 0.1% to 20%, more preferably from 0.3% to 10% and most preferably from 0.5% to 3%.

7. A composition according to any of the preceding claims which further comprise a surfactant or a mixture thereof, typically up to a level of 50% by weight of the total composition, preferably from 1% to 10% and more preferably from 1.5% to 5%.

8. A composition according to claim 7 wherein said surfactant is an anionic surfactant, nonionic surfactant, cationic surfactant, zwitterionic surfactant and/or amphoteric surfactant, preferably an anionic surfactant, more preferably a C4-C22 alkyl sulphate and most preferably a C6-C10 alkyl sulphate.

9. A composition according to any of the claims 5 to 8, wherein said polymer and said surfactant are present at a weight ratio of said polymer to said surfactant of 1:40 to 20:1, preferably of 1:20 to 10:1, more preferably of 1:10 to 5:1 and most preferably of 1:6 to 1:1.

10. A composition according to any of the preceding claims which further comprise a volatile organic compound or a mixture thereof, preferably at a level up to 90% by weight of the total composition and wherein said volatile compound preferably is a glycol ether and/or a derivative thereof, more preferably buthoxypropanol, propoxy ethyl acetate, ethanol-2-butoxy phosphate, 2-(hexyloxy)ethanol, 2-ethoxy ethanol, 2-butoxyethanol, n-butoxypropoxypropanol, butyl triglycol ether, butyl diglycol ether, 2-(2-alkoxyethoxy)ethanol, 2-(2-alkoxyethoxy)propanol, 2-(2-alkoxyethoxy)butanol or mixtures thereof, and/or a polyol, more preferably a diol, even more preferably 2-ethyl-1,3-hexanediol, 2,2,4-trimethyl-1,3-pentanediol, methyl-2,4 pentanediol or mixture thereof, and/or an aromatic alcohol according to the formula R₁—OH wherein R₁ is an alkyl substituted or non-alkyl substituted aryl group of from 1 to 20 carbon atoms, and/or an aliphatic alcohol according to the formula R₂—OH wherein R₂ is a linear or branched saturated or unsaturated hydrocarbon chain of from 1 to 20 carbon atoms, preferably from 2 to 10 and more preferably from 2 to 4 or mixtures thereof and most preferably is isopropanol.

11. A composition according to any of the preceding claims wherein the composition further comprises at least one optional ingredient selected from the group consisting of chelating agent, hydroxy-pyridine N-oxides and derivatives thereof, builder systems, perfumes, dyes, suds suppressing agents, enzymes, photobleaching agents, and mixtures thereof.

12. A composition according to any of the preceding claims which is an aqueous liquid composition having a pH of from 1 to 14, preferably between pH 1 and 7, more preferably between pH 2 and 6.5 and most preferably between pH 4 and 6.5

13. A method of cleaning and sanitising a carpet wherein a composition according to any of the preceding claims, is applied to said carpet, left to dry before being optionally removed from said carpet.

14. A method of cleaning and sanitising a carpet wherein a composition according to claim 13 is removed from said carpet by vacuum cleaning.

15. A composition or method according to any of the preceding claims wherein said composition is packaged in a container wherein the means for delivering the composition comprises an electrically driven pump and a spray arm being either extended or extendible and having at least one dispensing opening so that in operation, the composition is pumped by electrically driven pump from the container, through the spray arm to the dispensing opening from which it is dispensed.

16. The use of a liquid composition comprising a peroxygen bleach, said composition being packaged in a container adapted to deliver the composition in the form of a spray of droplets having a particle size distribution with a mean diameter D(v,0.9) of less than 1500 microns, for cleaning and sanitizing a carpet, for reducing the colour damage on said carpet.
